(19) United States
(12) Patent Application Publication
(10) Pub. No.: US 2025/0214364 A1
(43) Pub. Date: Jul. 3, 2025

(54) SYSTEMS AND METHODS FOR ORGANIZING ITEMS

(71) Applicant: Daniel Murphy, Katy, TX (US)

(72) Inventor: Daniel Murphy, Katy, TX (US)

(21) Appl. No.: 18/399,688

(22) Filed: Dec. 29, 2023

(51) Int. Cl. B42F 5/00; B42F 7/06; B42F 7/08

(52) U.S. Cl. CPC B42F 5/00; B42F 7/065; B42F 7/08

(57) ABSTRACT

A method for storing small, bulky items, that are not otherwise easily stored and an album binder for storing these types of items are disclosed. The method comprises storing items within an album binder equipped with pages. The pages comprise at least one pleated pocket designed to store items within. The pockets may be pleated on three sides to allow the pocket to expand in more than one direction and provide structural integrity to the pocket. In one embodiment, the album binder is designed to store electronic components including cords, cables, memory sticks, etc. In another embodiment, the album binder is designed to store an individual's medications and/or pill bottles.

### FIELD OF INVENTION

The inventions being presented relate to the storage of small, bulky items that are not otherwise easily or conveniently stored. Specifically, the present inventions related to methods and systems utilizing album binders with sleeved pockets that may also be pleated, specially designed to accommodate such items.

### BACKGROUND OF THE INVENTION

Album binders are most commonly used to store photographs or other flat-shaped media. The typical album binder is equipped with sheets that have slots, pockets, or other retaining mechanisms to ensure that items stored therein are secured in place and are protected. The major drawback of conventional pockets is the inability to accommodate three-dimensional objects. Such use eventually leads to the pockets ripping or tearing, causing the contents to be exposed, unsecured or movable from, or otherwise damaged.

Separately, electrical components such as various cords, electric cables, batteries, and the like are often stored mixed together in drawers, cupboards, or other miscellaneous containers. Electrical components are often comingled, making the individual cords difficult to find when needed. Similarly, other items such as sewing supplies and medications can be difficult to organize due to the various shapes and sizes.

U.S. Pub. No. 2002/0020092 A1 to Kurka discloses an album page that includes features enabling customization and personalization of photos and memorabilia. The album pages include panels (pages) with pockets, but the pockets aren't expandable. This particular album binder is designed to be more of a scrapbook meant to display photos, graphics, and/or other small apertures.

U.S. Pat. No. 6,390,715 B1 to Gerbasi discloses an apparatus and method for displaying and mailing advertisements using a transparent envelope with transparent pockets. The envelope of this apparatus is delivered to individuals as mailed advertisements.

U.S. Pub. No. 2016/0347509 A1 to Callan et al. discloses a storage unit for holding a cellphone (or other electronic device) in a plastic pocket that is meant to be attached to hospital beds.

U.S. Pub. No. 2004/0007866 A1 to Warriner et al. discloses album pages that are meant to store cards of varying sizes in pockets. The album pages comprise a backing sheet and multiple plastic pockets of varying sizes.

There is therefore a need for an improved method for storing bulky items, and an album binder equipped with pockets that will not rip or tear as a result of what is being stored within them, and that are specifically designed to store these types of non-flat, bulky media.

### SUMMARY OF THE INVENTION

To meet the needs described above and others, the present application discloses a method for storing small, bulky items utilizing a binder. While conventional methods of storing odd-shaped items typically involve intermingling items within containers, the present invention provides for an organized presentation of components using expandable pockets, that may be pleated, within a binder so that the items are separated, easy to view, and distinguishable from one another. The binder itself may comprise at least one ring to retain the sheets (e.g., a three-ring binder) or another mechanism of retaining multiple sheets.

According to one aspect of the invention, a method for storing and organizing items, the method comprising: providing an organizational system comprising: a binder, wherein the binder is configured to retain a plurality of sheets; at least one sheet of the plurality of sheets including at least one expandable pocket, wherein the at least one expandable pocket includes a front surface, opposing side surfaces, and a bottom surface, and at least one of the front surface, the opposing side surfaces, and the bottom surface is folded to allow the pocket to expand; opening the expandable pocket; positioning an item in the expandable pocket; and closing the organizational system.

According to another embodiment of the invention, the pockets also comprise a lid or enclosure mechanism. The lid or enclosure work to ensure that the contents with the pockets are not damaged upon exposure to liquid(s). In one embodiment, the lid or enclosure is simply an extra flap or piece of material without a further means for closing the pocket. In another embodiment, the pockets are enclosed via a strip of Velcro. In another embodiment, the pockets are enclosed via a button or snap enclosure. In yet another embodiment, the pockets are enclosed via an adhesive strip.

According to another embodiment of the invention, the album binders may be further equipped with separators or organizers within them to organize the contents within one singular binder. It is contemplated that one singular album binder may be used to store a variety of items, as opposed to storing entirely the same thing. However, it is also contemplated that one singular album binder may be used to store the same type of item entirely. Therefore, the separators may be used accordingly in order to organize the contents of a given album binder.

### BRIEF DESCRIPTION OF THE DRAWINGS

FIG. 1 depicts an organizational system of the present application.

FIGS. 2A-2C depict perspective views of different example embodiments of expandable pockets for use in the organizational system of FIG. 1.

FIG. 3 depicts a further embodiment of the organizational system of FIG. 1 including alternative pocket layouts.

FIG. 4 depicts a flow chart demonstrating a method of use of the organizational system of the present application.

### DETAILED DESCRIPTION

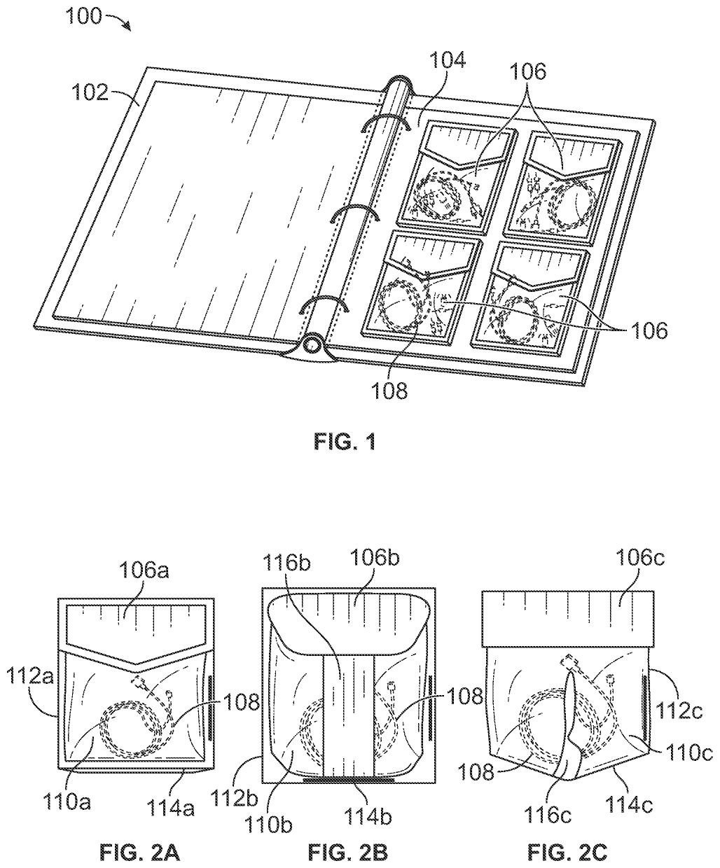

A preferred organizational system 100 of the present invention is disclosed in FIG. 1. The organizational system 100 includes a binder 102 having rings or another similar mechanism to retain a plurality of sheets 104 within. The sheets 104 include expandable, pleated pockets 106 that provide a three-dimensional cavity for storing small, bulky items 108 such as various electrical cords, flash drives or USB flash sticks, extension cords, plug modifiers, or the like. The pockets 106 expand in order to retain larger objects without breaking or tearing. In some embodiments, the pockets 106 are transparent to enable the user to view the contents within them easily. While FIG. 1 depicts electrical components within each pocket, the presently disclosed organizational system may be used to store a variety of types of products, such as medicines, sewing supplies, craft supplies, or other suitable items.

Referring to FIGS. 2A-2C, each expandable pocket 106 includes a front surface 110, opposing side surfaces 112, and a bottom surface 114 having folded or pleated features that enable the pocket to expand in order to accommodate bulky items having a three-dimensional shape. In the pocket 106a of FIG. 2A, the side and bottom surfaces 112a, 114a include an accordion fold, which allows the front surface 110a to move between a retracted, flattened position and an expanded, protruding position. The pocket 106b of FIG. 2B includes a front surface 110b having a length-wise pleat 116, allowing the front surface 110b to expand as needed. The front surface 110c of the pocket 106c of FIG. 2C has a wedge-shaped pleat 116c on the front of the pocket, as well as an accordion-like mechanism along sides that allows the pocket to open. The pockets 106a, 106b, 106c are capable of expanding considerably in three directions in order to accommodate the objects being stored within.

In a preferred embodiment, the organizational system 100 is also equipped with dividers to separate dissimilar items within the album binder and group similar items together. It is contemplated that the use of such dividers aids in the organization of items, and would allow a user to store or locate an item that is stored in the binder with greater efficiency.

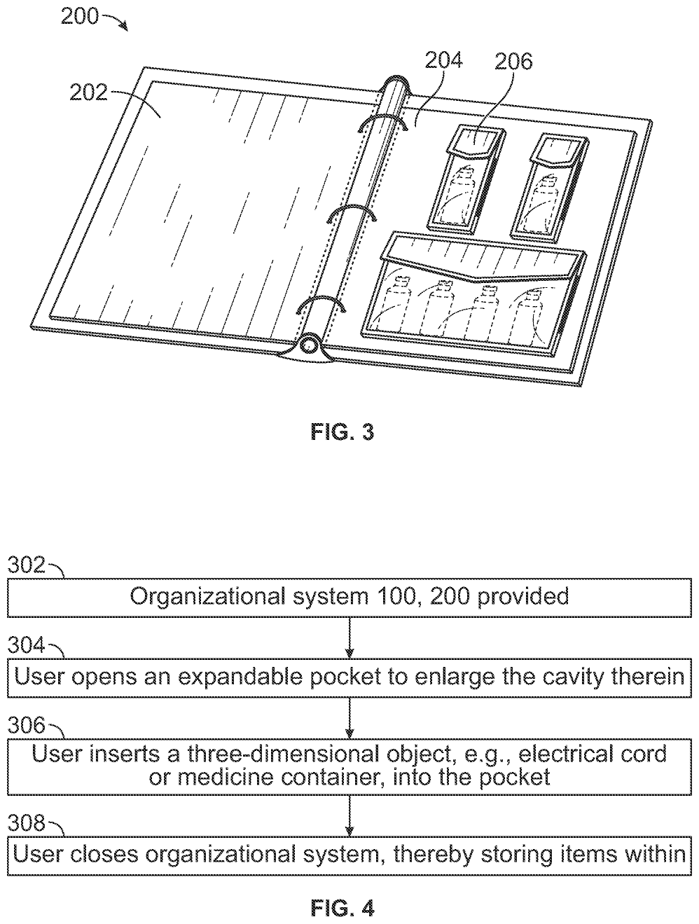

FIG. 3 depicts an organizational system 200 including a binder sheet 202 with two stacked expandable pockets holding medicine. It is contemplated that the pockets of the present invention allow for one to store medicine in individual pill or capsule form, or in the packaging or bottle the medication comes in. In other embodiments, the organizational system 100, 200 may be used to store sewing supplies, craft supplies, kids art supplies, game equipment, tools, and other items.

FIG. 4 depicts a flow chart illustrating a method 300 of use of the presently described organizational system 100, 200. In step 302, the organizational system 100, 200 as described above is provided. In step 304, a user opens an expandable pocket to enlarge the cavity therein. In step 306, the user inserts a three-dimensional object, such as an electrical cord, a medicine container, or the like, into the pocket. In step 308, the user closes the organizational system 100, 200.

In a preferred embodiment of the invention, the pockets 106 of FIG. 1 may be of uniform size as depicted, as well as non-uniform or varying in size depending on size of the item being placed within the pocket(s). This provides organizational system 100 the flexibility to store a variety of different items within it.

In a preferred embodiment of the invention, the pockets also comprise a lid or enclosure mechanism to keep the item(s) from falling out therefrom. Additionally, the lid or enclosure work to ensure that the contents with the pockets are not damaged upon exposure to liquid(s). In one embodiment, the lid or enclosure is simply an extra flap or piece of material without a further means for closing the pocket. In another embodiment, the pockets are enclosed via a strip of Velcro. In a further embodiment, the pockets are enclosed via a button or snap enclosure. In another embodiment, the pockets are enclosed via an adhesive strip or a zipper or zip-lock enclosure. In these embodiments, the lid or enclosure of the at least one pocket also provides a seal in order to protect the contents stored within the pockets.

In a preferred embodiment of the invention, the plurality of sheets include a plurality of expandable pockets configured to store electronic/electrical components. In one embodiment, the electronic/electrical components comprise at least one of: charging cables; charging devices; memory storage devices; Bluetooth devices; and/or batteries. It is also contemplated that these pockets may be used to store sewing supplies, craft supplies, kids art supplies, game equipment, tools, and other items.

It is also contemplated that the organizational system may be used by a variety of individuals in a wide range of fields. For example, school children may use an organizational system of the present invention to house all of their school supplies in one place. Or, a mechanic may use an organizational system of the present invention to house the various small components that a mechanic encounters in doing their job (nuts, bolts, o-rings, etc.).

In another embodiment of the invention, the method further comprises the step of labeling on an outer surface of the binder what type of items are stored within the binder. The binders may be labeled along their spines, on their covers, or both.

In another embodiment of the invention, the method further comprises the step of placing dividers within the album binder(s) to separate dissimilar items within the album binder and group similar items together. Therefore, the storage system is considered to be capable of storing one singular type of item within one individual binder, as well as storing a multitude of items within the same binder.

While the invention has been shown and described above with reference to specific figures and embodiments, those of ordinary skill in the art will understand the various changes and modifications that can be made within the scope of the invention. Any and all variations are considered to be encompasses by the claims below.

1. A method for storing and organizing items, the method comprising:
providing an organizational system comprising:
a binder, wherein the binder is configured to retain a plurality of sheets;
at least one sheet of the plurality of sheets including at least one expandable pocket;
wherein the at least one expandable pocket includes a front surface, opposing side surfaces, and a bottom surface; and
wherein at least one of the front surface, the opposing side surfaces, and the bottom surface is folded to allow the pocket to expand;
opening the expandable pocket;
positioning one of an electronic/electrical component or a medication container in the expandable pocket, the electronic/electrical component comprising at least one of: a charging cable, a charging device, a memory storage device, a Bluetooth device, or a battery; and
closing the organizational system.

2. The method of claim 1, wherein the at least one sheet includes a plurality of expandable pockets, and the expandable pockets of the plurality of expandable pockets are of uniform or non-uniform size.

3. The method of claim 2, wherein the expandable pockets of the plurality of expandable pockets are of non-uniform or varying sizes.

4. The method of claim 1, wherein the at least one expandable pocket is pleated across the front surface.

5. The method of claim 1, wherein the at least one expandable pocket is pleated along the sides of the pocket(s).

6. The method of claim 1, wherein the at least one pocket comprises at least one of: a flap enclosure; a snap or button enclosure; a Velcro enclosure; and/or an adhesive enclosure.

7. The method of claim 6, wherein the enclosure comprises a seal.

8. The method of claim 1, wherein each sheet of the plurality of sheets includes a plurality of expandable pockets configured to store electronic/electrical components.

9. The method of claim 8, wherein the electronic/electrical components comprise at least one of: charging cables; charging devices; memory storage devices; Bluetooth devices; and/or batteries.

10. The method of claim 1, further comprising labeling on an outside surface of the binder what type of items are being stored within the binder.

11. The method of claim 1, further comprising placing dividers within the album binder to separate dissimilar items within the binder and group similar items together.

12. The method of claim 11, further comprising placing only one type of the electronic/electrical component within a singular binder, thereby organizing a plurality of electronic/electrical components within the plurality of binders based on what is stored within the plurality of binders.

13. An organizational system comprising:
a binder, wherein the binder is configured to retain a plurality of sheets;
at least one sheet of the plurality of sheets including at least one expandable pocket to store one of an electronic/electrical component or a medication container, the electronic/electrical component comprising at least one of: a charging cable, a charging device, a memory storage device, a Bluetooth device, or a battery,
wherein the at least one expandable pocket includes a front surface, opposing side surfaces, and a bottom surface, and
at least one of the front surface, the opposing side surfaces, and the bottom surface is folded to allow the pocket to expand.

14. The organizational system of claim 13, wherein the at least one sheet includes a plurality of expandable pockets, and the expandable pockets of the plurality of expandable pockets are of uniform or non-uniform in size.

15. The organizational system of claim 14, wherein the expandable pockets of the plurality of expandable pockets are of non-uniform or varying sizes.

16. The organizational system of claim 13, wherein the at least one expandable pocket is pleated across the front surface.

17. The organizational system of claim 13, wherein the at least one pocket comprises at least one of: a flap enclosure; a snap or button enclosure; a Velcro enclosure; and/or an adhesive enclosure.

18. The organizational system of claim 17, wherein the enclosure comprises a seal.

19. The organizational system of claim 13, wherein the plurality of sheets include a plurality of expandable pockets configured to store electronic/electrical components.

20. The organizational system of claim 19, wherein the electronic/electrical components comprise at least one of: charging cables; charging devices; memory storage devices; Bluetooth devices; and/or batteries.
